(19) United States
(12) Patent Application Publication
(10) Pub. No.: US 2015/0069680 A1
(43) Pub. Date: Mar. 12, 2015

(54) ELECTROMAGNETIC PUMP, QUENCH TANK, AND LIQUID METAL LOOP

(71) Applicants: OSAKA UNIVERSITY, Suita-shi, Osaka (JP); MITSUBISHI HEAVY INDUSTRIES MECHATRONICS SYSTEMS, LTD., Kobe-shi, Hyogo (JP)

(72) Inventors: Shuhei Kuri, Hyogo (JP); Izuru Matsushita, Hyogo (JP); Hiroshi Horiike, Osaka (JP); Isao Murata, Osaka (JP); Eiji Hoashi, Osaka (JP); Sachiko Doi, Osaka (JP); Itsuro Kato, Osaka (JP)

(73) Assignees: OSAKA UNIVERSITY, Suita-shi, Osaka (JP); MITSUBISHI HEAVY INDUSTRIES MECHATRONICS SYSTEMS, LTD., Kobe-shi, Hygo (JP)

(21) Appl. No.: 14/386,529

(22) PCT Filed: Mar. 25, 2013
(86) PCT No.: PCT/JP2013/058588

§ 371 Date: Sep. 19, 2014

(30) Foreign Application Priority Data
Mar. 28, 2012 (JP) 2012-075214

(51) Int. Cl. H02K 44/06; C21D 1/62

(52) U.S. Cl. CPC H02K 44/06; C21D 1/62
USPC 266/241; 417/50

(57) ABSTRACT

A electromagnetic pump is configured that a housing includes therein an outer cylinder made of stainless steel, an inner cylinder made of stainless steel and arranged inside the outer cylinder, and an electromagnetic coil arranged around the outer cylinder. The outer cylinder is configured as a conical frustum having a large diameter in the inlet side and a small diameter in the outlet side. Similarly, the inner cylinder has a large diameter in the inlet side and a small diameter in the outlet side. A duct is formed between the outer cylinder and the inner cylinder. The radial cross sectional area of the duct is large in the inlet side and small in the outlet side.

### FIELD

The present invention relates to an electromagnetic pump, a quench tank, and a liquid metal loop used for circulations of liquid metals such as liquid lithium.

### BACKGROUND

Conventionally, an electromagnetic pump as described in Patent Literature 1 is known. The electromagnetic pump is configured that a plurality of stator iron-cores is radially arranged in the radially outer side of a concentric double cylinder and the stator iron-core is provided with a plurality of comb-teeth-shaped slots in each of which a plurality of annular coils is arranged. The concentric double cylinder is configured with an outer tube and an inner tube between which a duct is formed. The inner tube includes an inner iron-core for allowing lines of magnetic force to pass through. Further, both end portions of the inner tube are conically formed. The outer tube is connected to a circulation loop path of liquid sodium of a fast breeder reactor.

Each coil is arranged in order along the flow direction so as to form a three-phase alternating current winding so that a progressive magnetic field is generated along the flow direction in the duct when a three-phase alternating current is supplied to the coil of the electromagnetic pump. Further, a voltage is induced in the fluid by so-called the Fleming's right-hand rule to generate an induced current which produces the Lorentz force acting on the fluid itself. The liquid metal is transferred by the progressive magnetic field and the electromagnetic force generated by the induced current.

### CITATION LIST

### Patent Literature

Patent Literature 1: Japanese Patent Application Laid-open No. 62-178153

### SUMMARY

### Technical Problem

In a conventional loop, the height of the loop pipe is kept to be about 10 m in the inlet side of an electromagnetic pump so that the back pressure of the electromagnetic pump can be kept, thereby preventing cavitation. However, there is a problem that the large height of the loop pipe makes the apparatus large. The present invention is made to solve such problem.

### Solution to Problem

According to an aspect of the present invention, an electromagnetic pump includes: an outer cylinder; an inner cylinder; a duct that is formed between the outer cylinder and the inner cylinder to allow a conductive liquid to flow therethrough; and an electromagnetic coil provided in an outer side of the outer cylinder. A radial cross sectional area of the duct at an inlet side is larger than a radial cross sectional area at an outlet side.

When a large radial cross sectional area is provided in the inlet side of the duct, the flow velocity in the inlet side is reduced, which further prevents cavitation. Therefore, the height of the circulation loop of the conductive liquid to which the electromagnetic pump is applied can be reduced.

According to another aspect of the present invention, an electromagnetic pump includes: an outer cylinder; an inner cylinder; a duct that is formed between the outer cylinder and the inner cylinder to allow a conductive liquid to flow therethrough; and an electromagnetic coil provided in an outer side of the outer cylinder. An inner surface of the outer cylinder and an outer surface of the inner cylinder have inclination angles against an axial direction such that a radial cross sectional area of the duct at an inlet side is larger than a radial cross sectional area at an outlet side.

By providing inclination angle to the inner surface of an outer cylinder and the outer surface of an inner cylinder, the radial cross sectional area of the duct formed between the outer cylinder and the inner cylinder changes. As in such manner, when a larger radial cross sectional area is provided in the inlet side of the duct, the flow velocity in the inlet side can be reduced, which provides the effect of preventing cavitation as well as the effect of reducing the height of the loop.

Advantageously, in the electromagnetic pump, a radial gap between the outer cylinder and the inner cylinder is approximately same along an axial direction.

Since the electromagnetic coil uniformly generates the magnetic field in the duct, the magnetic flux density does not change drastically along the axial direction of the duct.

According to still another aspect of the present invention, an electromagnetic pump includes: an outer cylinder; an inner cylinder; a duct that is formed between the outer cylinder and the inner cylinder to allow a conductive liquid to flow therethrough; and an electromagnetic coil provided in an outer side of the outer cylinder. Either of an inner surface of the outer cylinder or an outer surface of the inner cylinder has an inclination angle against an axial direction such that a radial cross sectional area of the duct at an inlet side is larger than a radial cross sectional area at an outlet side, and the other is formed parallel to the axial direction.

Even for such configuration in which the radial cross sectional area of the duct formed between the outer cylinder and the inner cylinder changes, when a larger radial cross sectional area is provided in the inlet side of the duct, the flow velocity in the inlet side is reduced, which prevents cavitation and provides effect of reducing the height of the loop.

Advantageously, in the electromagnetic pump, control is carried out such that a high current is flowed in an inlet side of the electromagnetic coil.

That is, in the present invention, providing a larger gap between the outer cylinder and the inner cylinder in the inlet side may cause difference in the magnetic field in the duct between the inlet side and the outlet side, so that a larger current is provided to the inlet side of the electromagnetic coil to provide a uniform magnetic field along the axial direction of the duct. In this manner, the flow velocity in the inlet side can be reduced along the axial direction of the duct, thereby preventing cavitation.

According to still another aspect of the present invention, a quench tank, arranged in a circulation path of a liquid metal loop, for separating and cooling liquid metal steam or mixed gas in a liquid metal introduced in a tank main body, includes any of the electromagnetic pumps described above, an inlet side of which is connected to the tank main body.

According to still another aspect of the present invention, a liquid metal loop includes the quench tank described above.

### BRIEF DESCRIPTION OF DRAWINGS

FIG. 1 is a front view illustrating an electromagnetic pump according to a first embodiment of the present invention.

FIG. 2 is a radial cross sectional view taken along the line A-A of the electromagnetic pump illustrated in FIG. 1.

FIG. 3 is a cross sectional view taken along the line B-B of the electromagnetic pump illustrated in FIG. 1.

FIG. 4 is a front view illustrating an electromagnetic pump according to a second embodiment of the present invention.

FIG. 5 is a radial cross sectional view taken along the line A-A of the electromagnetic pump illustrated in FIG. 4.

FIG. 6 is a cross sectional view taken along the line B-B of the electromagnetic pump illustrated in FIG. 4.

FIG. 7 is a front view illustrating an electromagnetic pump according to a third embodiment of the present invention.

FIG. 8 is a radial cross sectional view taken along the line A-A of the electromagnetic pump illustrated in FIG. 7.

FIG. 9 is a cross sectional view taken along the line B-B of the electromagnetic pump illustrated in FIG. 7.

FIG. 10 is a front view illustrating a quench tank according to a fourth embodiment of the present invention.

FIG. 11 is a side view of the quench tank illustrated in FIG. 10.

FIG. 12 is a top view of the quench tank illustrated in FIG. 10.

FIG. 13 is a cross sectional view of the quench tank illustrated in FIG. 10.

FIG. 14 is a cross sectional view of a cylindrical body.

FIG. 15 is a cross sectional view illustrating a cylindrical body of a quench tank according to a fifth embodiment of the present invention.

FIG. 16 is a cross sectional view illustrating a quench tank according to a sixth embodiment of the present invention.

FIG. 17 is a cross sectional view taken along the line A-A in FIG. 16.

FIG. 18 is a cross sectional view illustrating a quench tank according to a seventh embodiment of the present invention.

FIG. 19 is a cross sectional view taken along the line A-A in FIG. 18.

FIG. 20 is a cross sectional view taken along the line B-B in FIG. 18.

FIG. 21 is a cross sectional view taken along the line C-C in FIG. 18.

FIG. 22 is a block diagram illustrating a liquid metal loop of the present invention.

### DESCRIPTION OF EMBODIMENTS

### First Embodiment

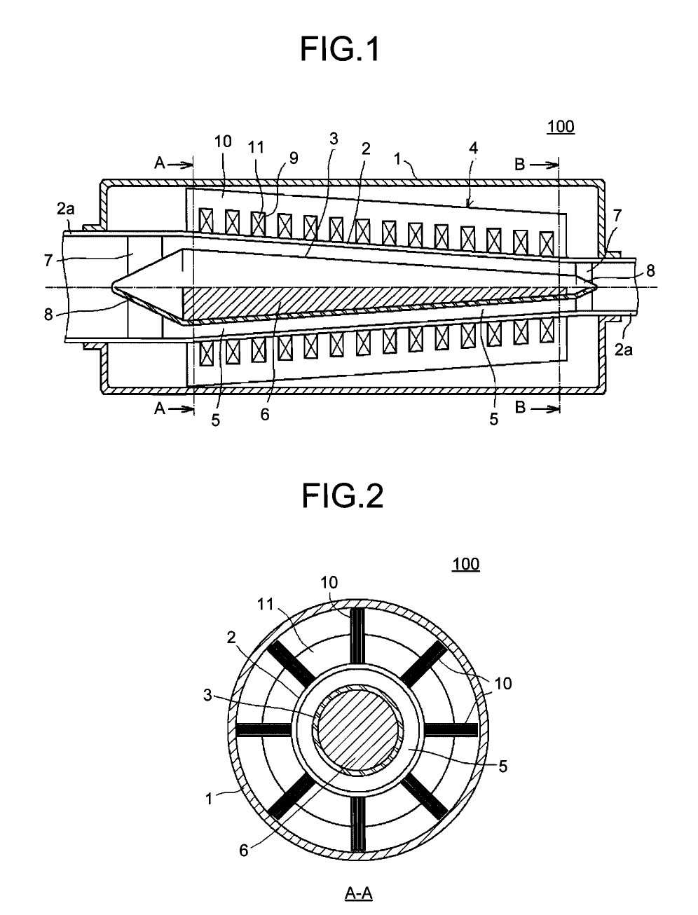

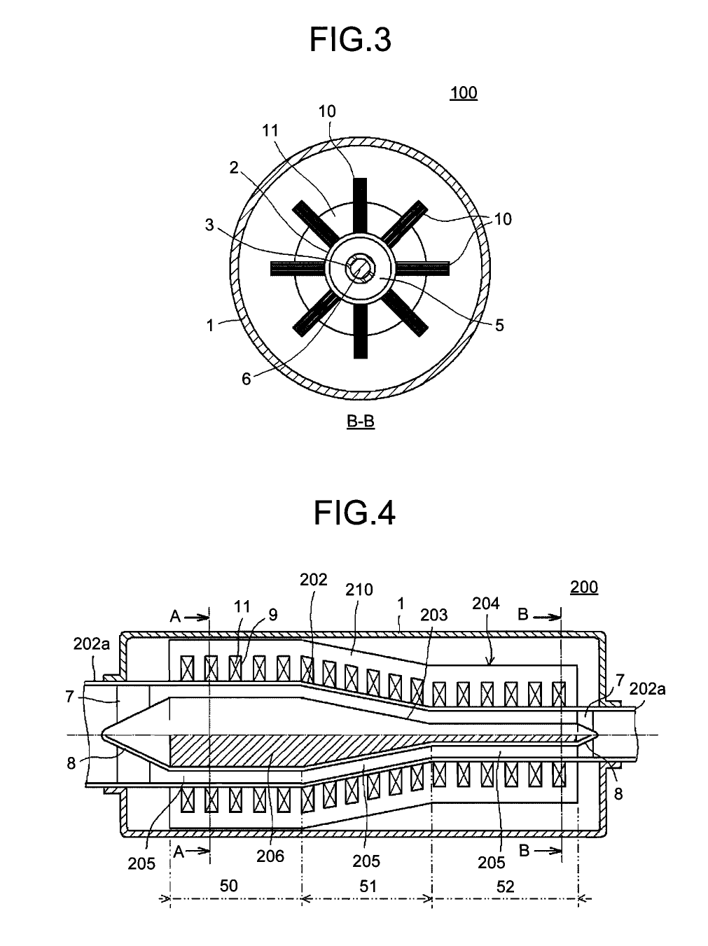

FIG. 1 is a cross sectional view along the flow direction of an electromagnetic pump according to a first embodiment of the present invention. FIG. 2 is a radial cross sectional view taken along the line A-A of the electromagnetic pump illustrated in FIG. 1. FIG. 3 is a cross sectional view taken along the line B-B of the electromagnetic pump illustrated in FIG. 1. An electromagnetic pump 100 is configured that a housing 1 includes therein an outer cylinder 2 made of stainless steel, an inner cylinder 3 made of stainless steel and arranged inside the outer cylinder 2, and an electromagnetic coil 4 arranged around the outer cylinder 2.

The outer cylinder 2 is configured as a conical frustum having a large diameter in the inlet side and a small diameter in the outlet side. Note that, the interface connected to the loop pipe (edge 2a of the outer cylinder) is provided as a straight pipe. Similarly, the inner cylinder 3 has a large diameter in the inlet side and a small diameter in the outlet side. A duct 5 is formed between the outer cylinder 2 and the inner cylinder 3. The duct 5, formed as a space between the outer cylinder 2 and the inner cylinder 3, has an annular shape. Further, the radial cross sectional area of the duct 5 is large in the inlet side and small in the outlet side.

An inner iron-core 6, which allows lines of magnetic force to pass through, is provided in the inner cylinder 3. A support plate 7 for supporting the inner cylinder 3 is radially provided between the outer circumferential surface of the inner cylinder 3 and the inner circumferential surface of the outer cylinder 2. The four support plates 7 are evenly provided along the circumferential direction at each of the portions near the front end and the rear end of the inner cylinder 3. A conical cap 8 is provided in each of the front portion and rear portion of the inner cylinder 3.

The electromagnetic coil 4 is configured with a stator iron-core 10 having a plurality of slots 9 formed in a comb-teeth shape and coils 11 arranged in the slots 9. A thin steel plate having slots 9 formed in a comb-teeth shape is laminated to form a laminated iron-core having a predetermined thickness. The stator iron-core 10 is configured with laminated iron-cores evenly arranged around the outer cylinder 2. The surface of the stator iron-core 10 opposing the outer cylinder is inclined along the inclination angle of the outer cylinder 2, so that the stator iron-core 10 makes contact with the outer circumferential surface of the outer cylinder 2 without a space in between when the stator iron-core 10 is arranged around the outer cylinder 2. The inclination angle is the angle of the inner surface of the outer cylinder 2 or the outer surface of the inner cylinder 3 against the axial direction of the electromagnetic pump 4.

The external of the stator iron-core 10 is supported by the inner circumferential surface of the housing 1. Further, the coil 11 wound in an annular shape is arranged in each slot 9. Each coil 11 is arranged in order along the flow direction of the liquid metal to form a three-phase alternating current winding. Since the difference in diameter between the inner cylinder 2 and the outer cylinder 3 is constant along the flow direction in the duct 5, uniform electromagnetic force can be applied to the liquid metal along the flow direction by supplying a constant current to the electromagnetic coil 4.

Now, the operation of the electromagnetic pump 100 will be described. When a three-phase alternating current is supplied to the coil 11 of the electromagnetic pump 100, a progressive magnetic field is generated in the flow direction in the duct 5. Further, a voltage is induced in the fluid by so-called the Fleming's rule to generate an induced current which produces the Lorentz force acting on the fluid itself. The liquid metal is transferred by the progressive magnetic field and the electromagnetic force generated by the induced current.

Further, as for the electromagnetic pump 100, since the cross sectional area of the duct 5 is large in the inlet side, the flow velocity of the liquid metal in the inlet side is reduced, thereby preventing cavitation in the electromagnetic pump 100. Therefore, the effect of reducing the height of the loop can be expected. In some cases, there will be no requirement for the loop height so that the apparatus can be made compact in size.

Further, the inclination angle of the outer cylinder 2 may be provided slightly larger than the inclination angle of the inner cylinder 3. In this manner, the cross sectional area of the duct 5 in the inlet side can be made larger than the cross sectional area of the duct 5 in the outlet side (not illustrated in the drawing).

### Second Embodiment

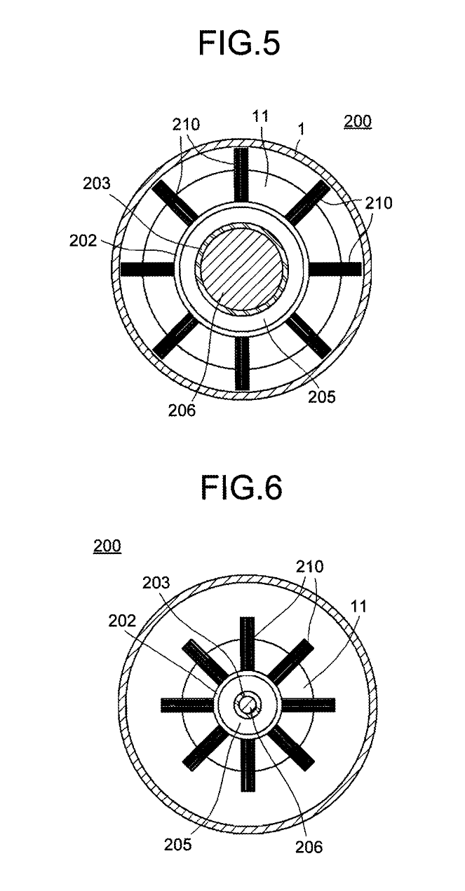

FIG. 4 is a cross sectional view along the flow direction of an electromagnetic pump according to a second embodiment of the present invention. FIG. 5 is a radial cross sectional view taken along the line A-A of the electromagnetic pump illustrated in FIG. 4. FIG. 6 is a cross sectional view taken along the line B-B of the electromagnetic pump illustrated in FIG. 4. An electromagnetic pump 200 is configured that a housing 1 includes therein an outer cylinder 202 made of stainless steel, an inner cylinder 203 made of stainless steel and arranged inside the outer cylinder 202, and an electromagnetic coil 204 arranged around the outer cylinder 202.

The outer cylinder 202 is configured of three blocks. A first block 50 is configured as a straight pipe having a large diameter extending along the axial direction, a second block 51 is configured as a conical frustum shape continuously extending from the first block 50, and a third block 52 is configured as a straight pipe having a smaller diameter than the first block 50 extending along the axial direction.

Similarly, the inner cylinder 3 is composed of a first block 50 configured as a straight circular pipe having a large diameter extending along the axial direction, a second block 51 configured as a conical frustum shape, and a third block 52 configured as a straight circular pipe having a small diameter extending along the axial direction. In the second block 51, the outer cylinder 202 and the inner cylinder 203 have the same inclination angle. The inclination angle is the angle of the inner surface of the outer cylinder 202 or the outer surface of the inner cylinder 203 against the axial direction of the electromagnetic pump 200.

A duct 205 is formed between the outer cylinder 202 and the inner cylinder 203. The duct 205, formed as a space between the outer cylinder 202 and the inner cylinder 203, has an annular shape. In the first block 50, the cross sectional area of the duct 205 is constant since both the outer cylinder 202 and the inner cylinder 203 are straight. In the second block 51, the cross sectional area of the duct 205 gradually decreases along the flow direction since the second block 51 is configured as a conical frustum. In the third block 52, the cross sectional area of the duct 205 is constant since both the outer cylinder 202 and the inner cylinder 203 are straight.

An inner iron-core 206, which allows lines of magnetic force to pass through, is provided in the inner cylinder 203. A support plate 7 for supporting the inner cylinder 203 is radially provided between the outer circumferential surface of the inner cylinder 203 and the inner circumferential surface of the outer cylinder 202. The four support plates 7 are evenly provided along the circumferential direction at each of the portions near the front end and the rear end of the inner cylinder 203. A conical cap 8 is provided in each of the front portion and rear portion of the inner cylinder 203. The tip of the cap 8 may have a spherical shape.

The electromagnetic coil 204 is configured with a stator iron-core 210 having a plurality of slots 9 formed in a comb-teeth shape and coils 11 arranged in the slots 9. A thin steel plate having slots 9 formed in a comb-teeth shape is laminated to form a laminated iron-core having a predetermined thickness. The stator iron-core 210 is configured with the laminated iron-cores evenly arranged around the outer cylinder 202. In the second block 51, the surface of the stator iron-core 210 opposing the outer cylinder is inclined along the inclination angle of the outer cylinder 202, so that the stator iron-core 210 makes contact with the outer circumferential surface of the outer cylinder 202 without a space in between when the stator iron-core 210 is arranged around the outer cylinder 202. The inclination angle is the angle of the inner surface of the outer cylinder 202 or the outer surface of the inner cylinder 203 against the axial direction of the electromagnetic pump 200.

The external of the stator iron-core 210 is supported by the inner surface of the housing 1. Further, the coil 11 wound in an annular shape is arranged in each slot 9. Each coil 11 is arranged in order along the flow direction of the liquid metal to form a three-phase alternating current winding. Since the difference in diameter between the inner cylinder 203 and the outer cylinder 202 is constant along the flow direction in the duct 205, uniform electromagnetic force can be applied to the liquid metal along the flow direction by supplying a constant current to the electromagnetic coil 204.

Even in the electromagnetic pump 200 configured as described above, since the cross sectional area of the duct 205 is large in the inlet side of the electromagnetic pump 200, the flow velocity in the inlet side is reduced, thereby preventing cavitation in the electromagnetic pump 200.

### Third Embodiment

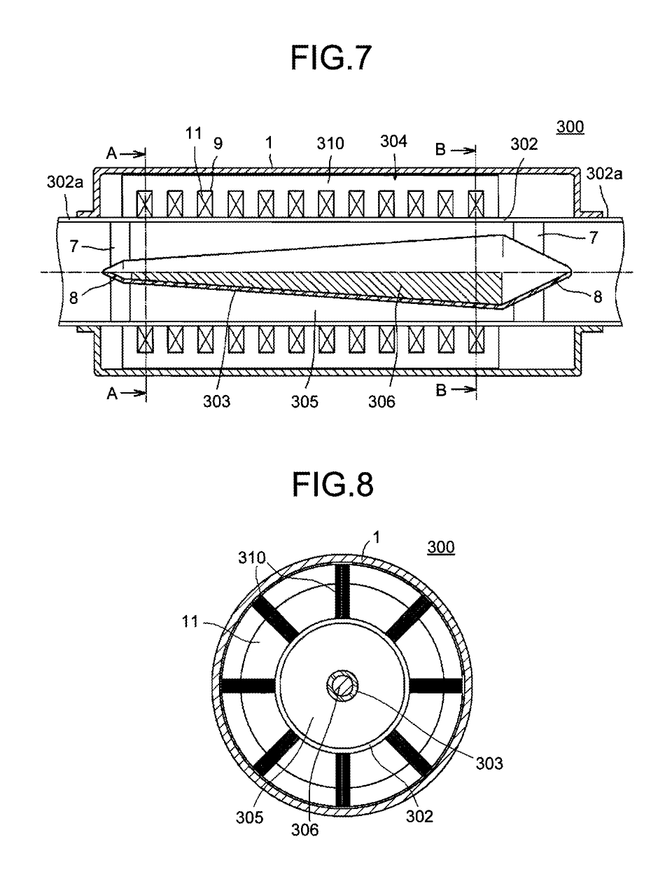

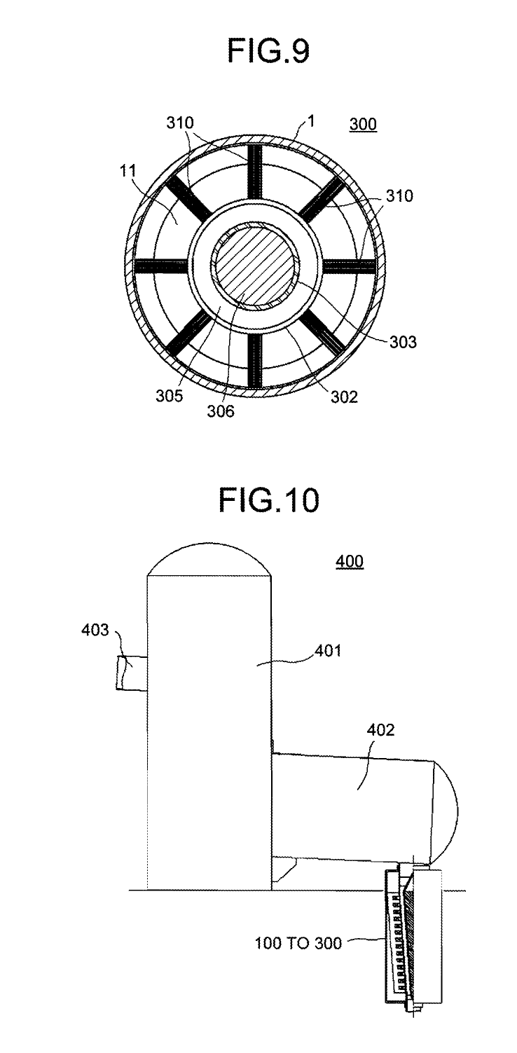

FIG. 7 is a cross sectional view along the flow direction of an electromagnetic pump according to the first embodiment of the present invention. FIG. 8 is a radial cross sectional view taken along the line A-A of the electromagnetic pump illustrated in FIG. 7. FIG. 9 is a radial cross sectional view taken along the line B-B of the electromagnetic pump illustrated in FIG. 7. The electromagnetic pump is configured that a housing 1 includes therein an outer cylinder 302 made of stainless steel, an inner cylinder 303 made of stainless steel and arranged inside the outer cylinder 302, and an electromagnetic coil 304 arranged around the outer cylinder 302.

The outer cylinder 302 is a straight pipe having an inner surface parallel to the axial direction. The inner cylinder 303 is configured as a conical frustum having a small diameter in the inlet side and a large diameter in the outlet side. A duct 305 is formed between the outer cylinder 302 and the inner cylinder 303. The duct 305, formed as a space between the outer cylinder 302 and the inner cylinder 303, has an annular shape. The inclination angle is the angle of the inner surface of the outer cylinder 302 or the outer surface of the inner cylinder 303 against the axial direction of the electromagnetic pump 300. Since the electromagnetic pump 300 according to the third embodiment has the inner cylinder 303 formed in a conical frustum, the cross sectional area of the duct 305 is large in the inlet side and small in the outlet side.

An inner iron-core 306, which allows lines of magnetic force to pass through, is provided in the inner cylinder 303. A support plate 7 for supporting the inner cylinder 303 is radially provided between the outer circumferential surface of the inner cylinder 303 and the inner circumferential surface of the outer cylinder 302. Four support plates 7 are evenly provided along the circumferential direction at each of the portions near the front end and the rear end of the inner cylinder 303. A conical cap 8 is provided in each of the front portion and rear portion of the inner cylinder 303. The tip of the cap 8 may have a spherical shape.

The electromagnetic coil 304 is configured with a stator iron-core 310 having a plurality of slots 9 formed in a comb-teeth shape and coils 11 arranged in the slots 9. A thin steel plate having slots 9 formed in a comb-teeth shape is laminated to form a laminated iron-core having a predetermined thickness. The stator iron-core 310 is configured with the laminated iron-cores evenly arranged around the outer cylinder 302. The surface of the stator iron-core 310 opposing the outer cylinder makes contact with the outer circumferential surface of the outer cylinder 302 without a space in between.

The external of the stator iron-core 310 is fixed to the inner surface of the housing 1. Further, the coil 11 wound in an annular shape is arranged in each slot 9. Each coil 11 is arranged in order along the flow direction of the liquid metal to form a three-phase alternating current winding. Since the difference in diameter between the inner cylinder 303 and the outer cylinder 302 gradually decreases along the flow direction in the duct 305, the current supplied to the electromagnetic coil 304 is raised in the inlet side to apply uniform electromagnetic force to the liquid metal along the flow direction.

Even in the electromagnetic pump 300 configured as described above, since the cross sectional area of the duct 305 is large in the inlet side, the flow velocity in the inlet side is reduced, thereby providing the effect of preventing cavitation in the electromagnetic pump 300.

Though not illustrated in the drawings, the outer cylinder may be configured as a conical frustum having a large diameter in the inlet side and a small diameter in the outlet side, and the inner cylinder may have a small diameter in the inlet side and the large diameter in the outlet side. Further, the outer cylinder may be configured as a conical frustum having a large diameter in the inlet side and a small diameter in the outlet side, and the inner cylinder may be configured as a circular pipe having the outer surface extending straight along the axial direction. Also in such configuration, since the area of the duct in the inlet side is larger than the outlet side, the similar effect can be obtained.

The electromagnetic pumps 100 to 300 according to the first to third embodiments can be applied to various plants and products such as a Boron Neutron Capture Therapy (BNCT) ( ) nuclear reactors, nuclear fusion reactors, fast breeder reactors, etc.

### Fourth Embodiment

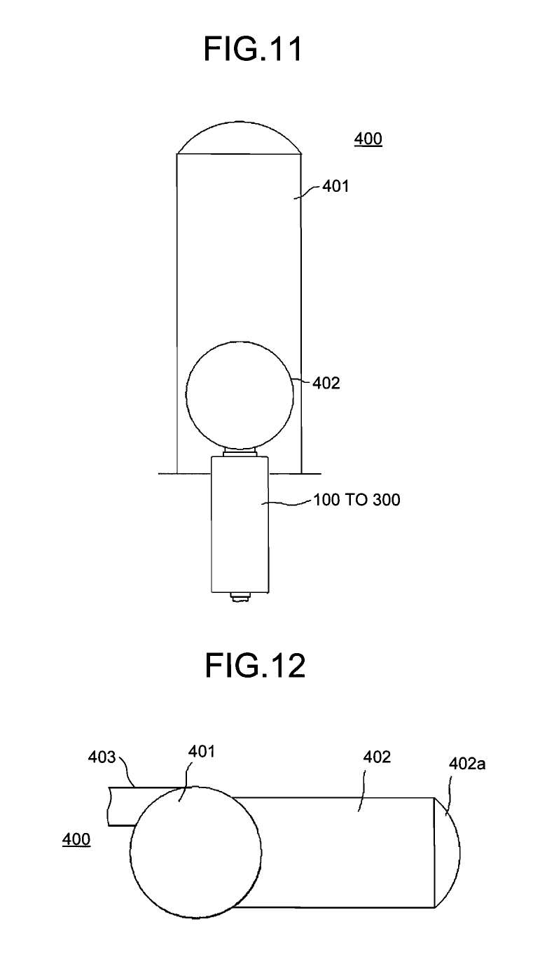

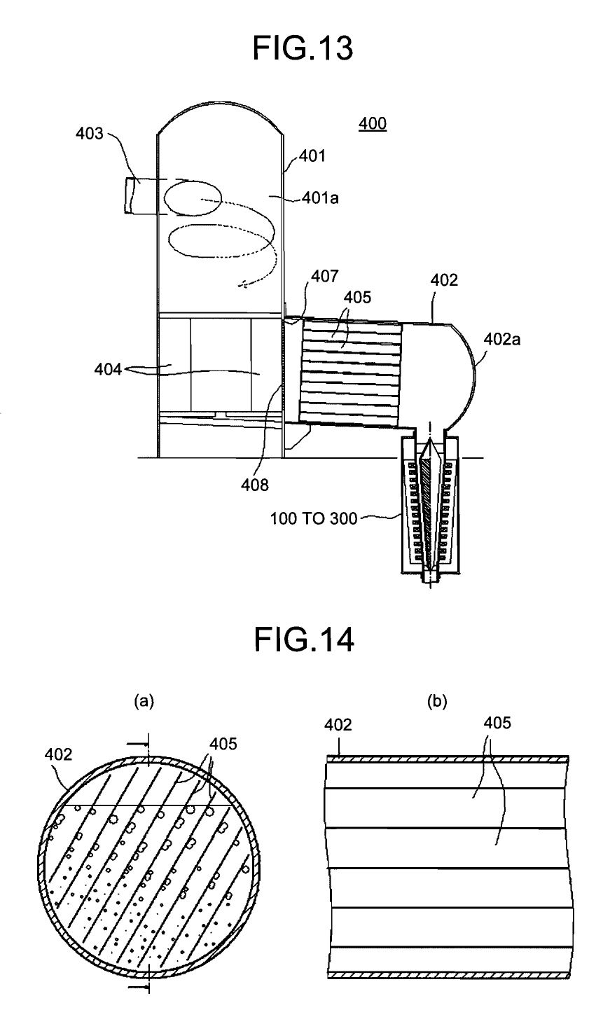

An example of the application of the electromagnetic pumps 100 to 300 of the present invention to a quench tank will be described below. FIG. 10 is a front view illustrating a quench tank according to a fourth embodiment of the present invention. FIG. 11 is a side view of the quench tank illustrated in FIG. 10. FIG. 12 is a top view of the quench tank illustrated in FIG. 10. FIG. 13 is a cross sectional view of the quench tank illustrated in FIG. 10. A quench tank 400 is configured with a tank main body 401 connected by a pipe to a receiver of a target forming unit which forms a liquid metal target and a cylindrical body 402 approximately horizontally provided in the bottom portion of the tank main body 401. The tank main body 401 has a cylindrical structure made by sheet metal processing. A pipe 403 from the target forming unit is provided on the upper side surface of the tank main body 401 so as to be tangential to the cylindrical shape of the tank main body 401. So that the liquid metal introduced from the pipe 403 circulates along an inner surface 401a of the tank main body 401 and enters a free liquid level (the flow of the liquid metal is illustrated in a dot-line arrow in the drawing). The target forming unit is configured with a nozzle for planarly jetting the liquid metal so as to cross the region irradiated with a proton beam and the receiver configured with a diffuser for receiving the jetted liquid metal.

In the lower part of the tank main body 401, four current plates 404 are radially provided from the axis of the cylinder so as to surround the central portion of the cylinder. The current plate 404 may be a flat plate, a mesh plate, or a punching metal. The number of current plates 404 is not limited to four.

The cylindrical body 402 is slightly inclined so as to lower a distal end 402a against the tank main body 401. Inside the cylindrical body 402, as illustrated in FIG. 14, a plurality of separation plates 405 is arranged so as to have inclination against the vertical direction. The gap between adjacent separation plates 405 is determined by an ascending rate of the bubble and a residence time in the cylindrical body, and preferably in a range of 3 cm to 5 cm specifically. The angle of the separation plate 405 is not limited. However, as illustrated in FIG. 14(a), the angle against the axial direction of the tank main body 401 is preferably in a range of 45 degrees to 60 degrees from the vertical direction. Further, as illustrated in FIG. 14(b), the separation plate 405 is provided throughout approximately the entire length of the cylindrical body 402. The length of the cylindrical body 402 is determined based on the capacity of separating bubbles.

An outlet for the liquid metal is provided in the downstream of the separation plate 405. The pipe connected to the outlet is connected to a pump constituting a liquid metal loop. The pipe extending from the pump is connected to the target forming unit via a heat exchanger. In this manner, the liquid metal loop is configured.

On the bottom, in the downstream side, of the cylindrical body 402, any of the electromagnetic pumps 100 to 300 described in the first to third embodiments is provided. Any of the electromagnetic pumps 100 to 300 is provided such that the side having the large cross sectional area of the duct is attached to the cylindrical body 402. The outlet of any of the electromagnetic pumps 100 to 300 is connected to the pipe of the circulation loop.

Now, the behavior of the liquid metal in the quench tank will be described. The liquid metal of which temperature is raised by irradiation with a proton beam is introduced from the target forming unit to the tank main body 401 through a pipe 3. Since the pipe 403 is connected to the tank main body 401, tangential to the cylindrical shape, the introduced liquid metal circulates along the inner surface 401a of the tank main body 401 and enters the free liquid level. In this step, the bubble is introduced from the free liquid level.

After circulatingly entering the free liquid level, the liquid metal swirlingly moves in the tank main body 401. The current plate 404 provided inside the lower part of the main body stops the circulation of the liquid metal, and the liquid metal rests in the lower part of the tank main body 401. On the side surface of the lower part of the tank main body 401, a hole 407 corresponding to the cylindrical body 402 is provided. The tank main body 401 and the cylindrical body 402 communicates through the hole 407. A second current plate 408 formed of a mesh plate or a punching metal is provided on the hole 407. As illustrated in FIG. 14(a), as the liquid metal flows along the longitudinal direction of the cylindrical body 402, the bubble included in the liquid metal ascends. Since the separation plates 405 are arranged in the cylindrical body with a predetermined small gap therebetween, the bubble ascends for a short distance to hit against the surface of the separation plate 405 and grows by uniting with other bubbles.

As the bubble grows, the buoyancy of the bubble increases, raising the ascending rate of the bubble. Thus, the bubble ascends by rollingly moving along the inclined surface of the separation plate 405. The bubble unites with nearby bubbles to grow during the ascending and further increases its volume until the bubble reaches the free liquid level. Such process happens in each space between separation plates 405. The grown bubble in the liquid metal flowing along the longitudinal direction of the cylindrical body 402 disappears when the bubble reaches the free interface. When the bubble grows and the ascending rate increases, the bubble ascends within a shorter time, which can efficiently remove the bubble and reduce the length of the cylindrical body 402.

Then, the liquid metal from which sufficient amount of bubble is removed is suctioned by any of the electromagnetic pumps 100 to 300 to be transferred to the circulation loop. Since the electromagnetic pumps 100 to 300 have a large duct cross sectional area in the inlet side, sufficient back pressure can be kept without providing a large loop height, so that the cavitation in the electromagnetic pumps 100 to 300 can efficiently be prevented. The electromagnetic pumps 100 to 300 transfer the liquid metal again to the target forming unit.

When the liquid metal is jetted to form a target, bubbles are likely to be mixed into the liquid metal in the receiver. Therefore, it is extremely useful to remove the bubble in the cylindrical body 402 for the case in which the target is formed by the liquid metal jet.

As described above, according to the quench tank 400 of the present invention, by providing a plurality of separation plates 405 in the cylindrical body 402, the separation plate 405 can grow and remove the bubble rapidly in the flowing liquid metal. Therefore, the length of the cylindrical body 402 can be reduced, enabling downsizing of the quench tank 400. Further, since the cavitation in the electromagnetic pumps 100 to 300 can be prevented, mixing of bubbles in the circulation loop can be minimized.

The target forming unit may be a conventional type in which a liquid metal is supplied with high speed to a curved back plate to form a liquid film.

### Fifth Embodiment

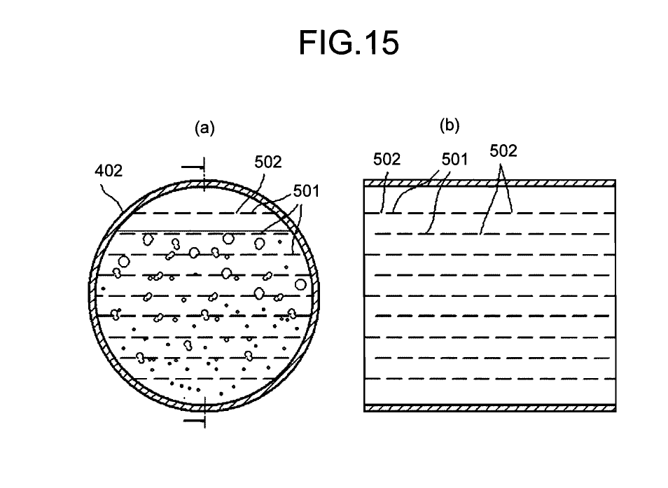

FIG. 15 is a cross sectional view illustrating a cylindrical body of the quench tank according to a fifth embodiment of the present invention. The quench tank has an approximately the same configuration as the fourth embodiment but differs in the shape and arrangement of the separation plate 5. The rest of the configuration is same as the quench tank 400 of the fourth embodiment, and therefore will not be described. In the quench tank, a punching metal having a plurality of holes 502 is provided as a separation plate 501. A plurality of separation plates 501 is approximately horizontally arranged. The liquid metal flowing down from the tank main body 401 passes through a plurality of layered separation plates 501. The bubble included in the liquid metal hits against the back surface of each separation plate 501 to grow by uniting with other bubbles. The buoyancy of the bubble increases as the bubble grows, and the bubble ascends through the hole 502 of the separation plate 501. The bubble grows at the separation plate 501 in the upper layer by further absorbing other bubbles and ascends through the hole 502. Finally, the grown bubble having a large volume reaches the free interface of the liquid metal in the cylindrical body 2 and disappears.

The separation plate 502 formed of a punching metal also grows the bubble and increases its ascending speed, so that the horizontal distance required for separating the bubble can be reduced. Therefore, the cylindrical body can be shortened, enabling downsizing of the quench tank.

Although not illustrated in the drawing, the similar effect can be obtained by configuring the separation plate 501 with a mesh plate. That is, when a bubble grows by hitting against the surface of the mesh, the ascending speed of the bubble increases. The growing bubble gains larger buoyancy and moves to the upper layer through the mesh. After further continuing growing, the bubble disappears upon reaching the free liquid level of the liquid metal. As described above, when the bubble grows and increases its ascending speed, the bubble can be removed within a shorter time. Thereby, the bubble can efficiently be removed so that the length of the cylindrical body can be shortened. The optimum mesh size is determined by the tank capacity, the flow velocity of the liquid metal, etc.

### Sixth Embodiment

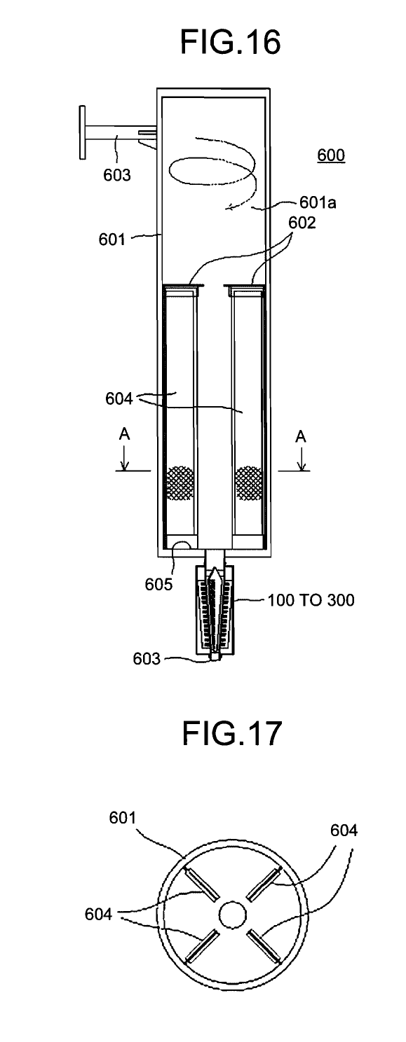

FIG. 16 is a cross sectional view illustrating a quench tank according to a sixth embodiment of the present invention. FIG. 17 is a cross sectional view taken along the line A-A in FIG. 16. A quench tank 600 has a cylindrical tank main body 601, and a pipe 603 from the target forming unit described above is connected to the upper part of the tank main body 601. Further, the pipe 603 is tangentially provided to the cylindrical body. SO that the liquid metal introduced from the pipe 603 circulates along the inner surface 601a of the tank main body 601 and enters the free liquid level.

In the lower part of the tank main body 601, four current plates 604 are radially provided from the axis of the cylinder so as to surround the central portion of the cylinder. The current plate 604 is preferably a mesh plate to promote adhesion of the bubble. Otherwise, the current plate 604 may be a punching metal in which a large number of small holes are formed. The number of the current plates 604 is not limited to four. The upper part of the current plate 604 is supported by a support plate 602, and the lower part of the current plate 604 is supported by a bottom plate 605 of the tank main body 601. The length of the current plate 604 is determined based on the required performance of removing bubbles.

On the bottom portion 605 of the tank main body 601, any of the electromagnetic pumps 100 to 300 according to the first to third embodiment is provided. Any of the electromagnetic pumps 100 to 300 is provided such that the side having the large cross sectional area of the duct is attached to the tank main body 601. The outlet of any of the electromagnetic pumps 100 to 300 is connected to the pipe 603 of the circulation loop. The pipe 603 extending from any of the electromagnetic pumps 100 to 300 is connected to the target forming unit via a heat exchanger. In this manner, the liquid metal loop is configured.

Now, the behavior of the liquid metal in the quench tank will be described. The liquid metal of which temperature is raised by irradiation with a proton beam is introduced from the target forming unit to the tank main body 601 through the pipe 603. Since the pipe 603 is connected to the tank main body 601, tangential to the cylindrical shape, the introduced liquid metal circulates along the inner surface of the tank main body 601 and enters the free liquid level. In this step, the bubble is introduced from the free liquid level.

After circulatingly entering the free liquid level, the liquid metal swirlingly moves in the tank main body 601. The current plate 604 provided inside the lower side of the main body stops the circulation of the liquid metal, and the liquid metal rests in the lower part of the tank main body 601. The bubble included in the liquid metal touches the current plate 604 and adheres thereto, and then grows by uniting with adjacent bubbles. The buoyancy of the bubble increases as the bubble grows, and the bubble ascends along the current plate 604. During the process, the bubble continues growing by absorbing small bubbles existing nearby. The grown bubble obtains higher ascending rate in the liquid metal and finally disappears upon reaching the free liquid level in the tank main body 601.

The liquid metal from which sufficient amount of bubble is removed is suctioned by any of the electromagnetic pumps 100 to 300 to be transferred to the circulation loop. Since the electromagnetic pumps 100 to 300 have a large duct cross sectional area in the inlet side, sufficient back pressure can be kept without providing a large loop height, so that the cavitation in the electromagnetic pumps 100 to 300 can efficiently be prevented. The electromagnetic pumps 100 to 300 transfer the liquid metal again to the target forming unit.

As described above, according to the quench tank 600 of the present invention, by providing a plurality of separation plates 604 in the lower part of the tank main body 601, the separation plate 604 can grow and rapidly remove the bubble in the flowing liquid metal. Therefore, the separation region of the bubble can be reduced compared to the case in which the bubble ascends without using any additional means. As a result, the quench tank 600 can be downsized. Further, since cavitation in the electromagnetic pump is prevented, mixing of bubbles into the circulation loop can be minimized.

### Seventh Embodiment

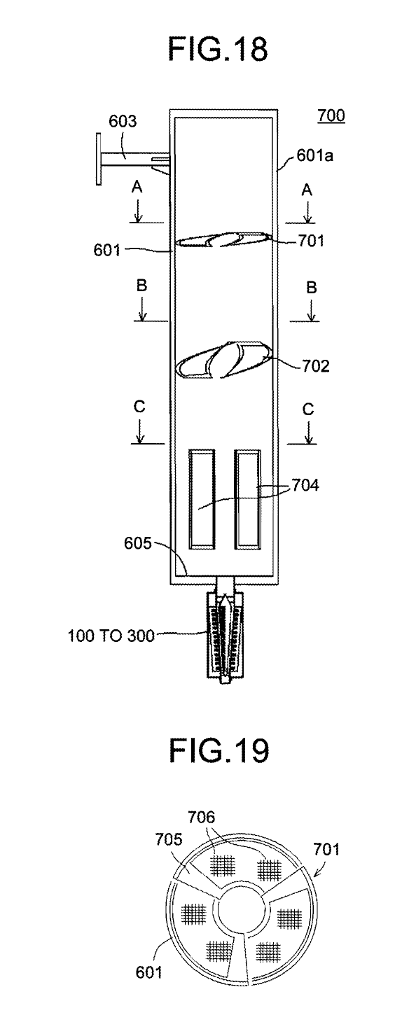

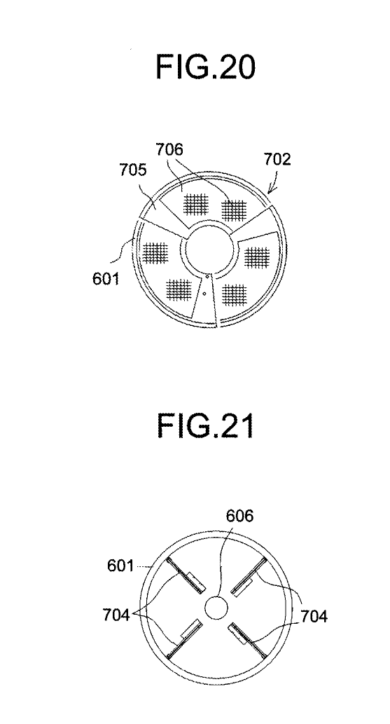

FIG. 18 is a cross sectional view illustrating a quench tank according to a seventh embodiment of the present invention. FIG. 19 is a cross sectional view taken along the line A-A in FIG. 18. FIG. 20 is a cross sectional view taken along the line B-B in FIG. 18. FIG. 21 is a cross sectional view taken along the line C-C in FIG. 18. A quench tank 700, having an approximately the same configuration as the quench tank 600 of the sixth embodiment, is characterized in that the dimensions of a current plate 704 is reduced and a wing-shaped current plate is provided above the current plate 704. The rest of the configuration is same as the quench tank 600 of the sixth embodiment, so that the descriptions on those parts are omitted, and the same component is appended with the same reference sign. The quench tank 700 includes an upper wing 701 and a lower wing 702. Each of the upper wing 701 and the lower wing 702 is configured with three wings.

The upper wing 701 and the lower wing 702 have predetermined inclined shapes. The surface of the wing is configured with a mesh member 706 provided in a metal plate frame 705. Inclination angles of the upper wing 701 and the lower wing 702 are determined based on the flow angle of the liquid metal along the inner wall of the tank main body 601. The inclination angle of the upper wing 701 is more gradual than the lower wing 702.

The angle between the flow direction of the liquid metal flowing along the inner wall 601a of the tank main body 601 and the vertical direction gradually decreases as the liquid metal flows from the upper part to the middle portion of the tank main body 601. In the upper part of the tank main body 601, the introduced liquid metal circulates with high velocity so that the angle between the flow direction of the liquid metal and the vertical direction is large. Therefore, the inclination angle of the upper wing 701 is set to a large angle corresponding to the flow direction of the liquid metal.

Similarly, the inclination angle of the lower wing 702 is set corresponding to the angle of flow direction of the liquid metal in the middle portion of the tank main body 601. The four current plates 704 provided in the lower part of the tank main body 601 are slightly smaller than those of the sixth embodiment. The function of the current plate 704 is same as the sixth embodiment described above.

The behavior of the liquid metal in the quench tank will be described. The liquid metal of which temperature is raised by irradiation with a proton beam is introduced from the target forming unit to the tank main body 601 through the pipe 603. Since the pipe 603 is connected to the tank main body 601, tangential to the cylindrical shape, the introduced liquid metal circulates along the inner surface of the tank main body 601.

The upper wing 701 guides the liquid metal to maintain its circulating direction. That is, the upper wing 701 maintains the flow direction of the liquid metal along the inner surface of the tank main body 601 so as to prevent the liquid metal from abruptly changing the descending angle. Subsequently, the lower wing 702 further maintains the flow direction of the liquid metal, and consequently, the liquid metal is smoothly introduced to the free liquid level. The current plate 704 provided inside the lower side of the tank main body 601 stops the circulation of the liquid metal, and the liquid metal rests in the lower part of the tank main body 601. The bubble included in the liquid metal touches the current plate 704 and adheres thereto, and then grows by uniting with adjacent bubbles.

The buoyancy of the bubble increases as the bubble grows, and the bubble ascends along the current plate 704. During the process, the bubble continues growing by absorbing small bubbles existing nearby. The grown bubble obtains higher ascending rate in the liquid metal and finally disappears upon reaching the free liquid level in the tank main body 601.

The liquid metal from which sufficient amount of bubble is removed is suctioned by any of the electromagnetic pumps 100 to 300 to be transferred to the circulation loop. Since the electromagnetic pumps 100 to 300 have a large duct cross sectional area in the inlet side, sufficient back pressure can be kept without providing a large loop height, so that the cavitation in the electromagnetic pumps 100 to 300 can efficiently be prevented. The electromagnetic pumps 100 to 300 transfer the liquid metal again to the target forming unit.

As described above, according to the quench tank 700 of the present invention, the upper wing 701 and the lower wing 702 guide the liquid metal to enter the free liquid level with moderate speed, so that the bubble is not likely to be produced. Further, since the separation plate 704 grows and rapidly removes the bubble, the separation region of the bubble can be reduced compared to the case in which the bubble ascends without using any additional means. As a result, the quench tank 700 can be downsized. Further, since the cavitation in the electromagnetic pumps 100 to 300 can be prevented, mixing of bubbles in the circulation loop can be minimized.

### Eighth Embodiment

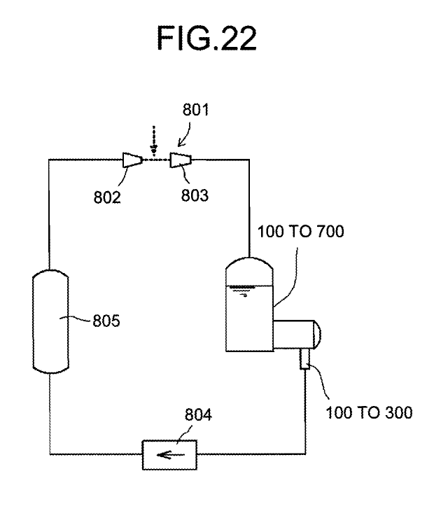

FIG. 22 is a block diagram illustrating a liquid metal loop of the present invention. A liquid metal loop 800 includes any of the quench tanks 400 to 700 according to the fourth to seventh embodiments in the circulation path. A target forming unit 801 of the liquid metal loop 800 is configured with a nozzle 802 for planarly jetting the liquid metal so as to cross the region irradiated with a proton beam and a receiver 803 configured with a diffuser for receiving the jetted liquid metal. Thus, bubbles are easily mixed in the liquid metal in the receiver 803. The bubble included in the liquid metal is removed in any of the quench tanks 400 to 700. The liquid metal, from which the bubble is removed, is transferred to any of the electromagnetic pumps 100 to 300. Since the electromagnetic pumps 100 to 300 can sufficiently reduce pressure loss, cavitation can efficiently be prevented in the electromagnetic pumps 100 to 300. The electromagnetic pumps 100 to 300 transfer the liquid metal again to the target forming unit 801 through a heat exchanger 805.

According to the liquid metal loop 800, since the target is formed by the jet of the liquid metal, a back plate behind the liquid metal is not necessary as in the conventional art. Therefore, the damage of a structure by a neutron can be suppressed. The quench tanks 400 to 700 are preferable for such target forming unit 801.

Further, according to the embodiment described above, the aspect of the present invention can be specified as described below.

A quench tank, arranged in a circulation path of the liquid metal loop, for separating and cooling liquid metal steam or mixed gas included in the liquid metal introduced in the tank main body is provided. The quench tank is characterized in that the tank main body has a separation region for forming an approximately horizontal flow of the liquid metal, a separation plate configured of a plate having a plurality of holes or a mesh plate is arranged in the separation region so as to be approximately horizontal to the flow direction of the liquid metal, and an inlet side of any of the electromagnetic pumps according to the first to third embodiments is connected to the separation region.

A quench tank, arranged in a circulation path of the liquid metal loop, for separating and cooling liquid metal steam or mixed gas included in the liquid metal introduced in the tank main body is provided. The quench tank is characterized in that the tank main body has a separation region for forming an approximately horizontal flow of the liquid metal, a separation plate, tilted toward the vertical direction, configured of a plate having a plurality of holes or a mesh plate is arranged in the separation region, and an inlet side of any of the electromagnetic pumps according to the first to third embodiments is connected to the separation region.

A quench tank, arranged in a circulation path of the liquid metal loop, for separating and cooling liquid metal steam or mixed gas included in the liquid metal introduced in the tank main body is provided. The quench tank is characterized in that the tank main body has a separation region for forming an approximately horizontal flow of the liquid metal, a separation plate which is curved about the longitudinal axis such that the cross section has at least one inverted concave shape, and is provided with a hole in the middle portion which is an apex of the inverted concave shape and/or in the mid slope, is arranged in the separation region, and an inlet side of any of the electromagnetic pumps according to the first to third embodiments is connected to the separation region.

A quench tank, arranged in a circulation path of the liquid metal loop, for separating and cooling liquid metal steam or mixed gas included in the liquid metal introduced in the tank main body is provided. The quench tank is characterized as follows. The tank main body has a separation region, connected to the tank main body, for forming an approximately vertical flow of the liquid metal. A separation plate having a concave shape provided with a hole in the middle portion which is the bottom of the concave shape and a small hole in the mid slope between the edge and the bottom of the concave shape is arranged in the separation region such that the distance between the bottom of the separation plate and the bottom plane of the separation region is kept in a predetermined gap. An introducing port for introducing the liquid metal from the tank main body is provided between the separation plate in the separation region and the bottom plane of the separation region. An outlet for the liquid metal is provided above the separation plate in the separation region. Further, an inlet side of any of the electromagnetic pumps according to the first to third embodiments is connected to the separation region.

Note that, the separation region may be separated from the tank main body.

A quench tank, arranged in a circulation path of the liquid metal loop, for separating and cooling liquid metal steam or mixed gas included in the liquid metal introduced in the tank main body is provided. The quench tank is characterized in that a separation plate configured of a mesh plate or a punching plate is vertically arranged in the lower part of the tank main body, and an inlet side of any of the electromagnetic pumps according to the first to third embodiments is connected to the bottom part of the tank main body. Further, a wing having an inclination angle corresponding to the flow angle, along the inner surface of the tank main body, of the liquid metal may be provided above the separation plate in the tank main body.

### REFERENCE SIGNS LIST

100 electromagnetic pump
1 housing
2 outer cylinder
3 inner cylinder
4 electromagnetic coil
5 duct
6 inner iron-core
9 slot
10 stator iron-core
11 coil

1. An electromagnetic pump comprising:
an outer cylinder;
an inner cylinder;
a duct that is formed between the outer cylinder and the inner cylinder to allow a conductive liquid to flow therethrough; and
an electromagnetic coil provided in an outer side of the outer cylinder, wherein
a radial cross sectional area of the duct at an inlet side is larger than a radial cross sectional area at an outlet side.

2. An electromagnetic pump comprising:
an outer cylinder;
an inner cylinder;
a duct that is formed between the outer cylinder and the inner cylinder to allow a conductive liquid to flow therethrough; and
an electromagnetic coil provided in an outer side of the outer cylinder, wherein
an inner surface of the outer cylinder and an outer surface of the inner cylinder have inclination angles against an axial direction such that a radial cross sectional area of the duct at an inlet side is larger than a radial cross sectional area at an outlet side.

3. The electromagnetic pump according to claim 2, wherein a radial gap between the outer cylinder and the inner cylinder is approximately same along an axial direction.

4. An electromagnetic pump comprising:
an outer cylinder;
an inner cylinder;
a duct that is formed between the outer cylinder and the inner cylinder to allow a conductive liquid to flow therethrough; and
an electromagnetic coil provided in an outer side of the outer cylinder, wherein
either of an inner surface of the outer cylinder or an outer surface of the inner cylinder has an inclination angle against an axial direction such that a radial cross sectional area of the duct at an inlet side is larger than a radial cross sectional area at an outlet side, and the other is formed parallel to the axial direction.

5. The electromagnetic pump according to claim 1, wherein control is carried out such that a high current is flowed in an inlet side of the electromagnetic coil.

6. The electromagnetic pump according to claim 2, wherein control is carried out such that a high current is flowed in an inlet side of an electromagnetic coil.

7. The electromagnetic pump according to claim 4, wherein control is carried out such that a high current is flowed in an inlet side of the electromagnetic coil.

8. A quench tank, arranged in a circulation path of a liquid metal loop, for separating and cooling liquid metal steam or mixed gas in a liquid metal introduced in a tank main body, comprising
the electromagnetic pumps according to claim 1, an inlet side of which is connected to the tank main body.

9. A liquid metal loop comprising the quench tank according to claim 8.

10. A quench tank, arranged in a circulation path of a liquid metal loop, for separating and cooling liquid metal steam or mixed gas in a liquid metal introduced in a tank main body, comprising
the electromagnetic pump according to claim 2, an inlet side of which is connected to the tank main body.

11. A quench tank, arranged in a circulation path of a liquid metal loop, for separating and cooling liquid metal steam or mixed gas in a liquid metal introduced in a tank main body, comprising
the electromagnetic pump according to claim 3, an inlet side of which is connected to the tank main body.

12. A quench tank, arranged in a circulation path of a liquid metal loop, for separating and cooling liquid metal steam or mixed gas in a liquid metal introduced in a tank main body, comprising
the electromagnetic pump according to claim 4, an inlet side of which is connected to the tank main body.

13. A quench tank, arranged in a circulation path of a liquid metal loop, for separating and cooling liquid metal steam or mixed gas in a liquid metal introduced in a tank main body, comprising
the electromagnetic pump according to claim 5, an inlet side of which is connected to the tank main body.

14. A quench tank, arranged in a circulation path of a liquid metal loop, for separating and cooling liquid metal steam or mixed gas in a liquid metal introduced in a tank main body, comprising
the electromagnetic pump according to claim 6, an inlet side of which is connected to the tank main body.

15. A quench tank, arranged in a circulation path of a liquid metal loop, for separating and cooling liquid metal steam or mixed gas in a liquid metal introduced in a tank main body, comprising
the electromagnetic pump according to claim 7, an inlet side of which is connected to the tank main body.
